(19) United States
(12) Patent Application Publication
(10) Pub. No.: US 2023/0059365 A1
(43) Pub. Date: Feb. 23, 2023

(54) ELECTROPLATING AND ETCHING SYSTEM AND METHOD

(71) Applicant: David Sapiro, Seattle, WA (US)

(72) Inventor: David Sapiro, Seattle, WA (US)

(21) Appl. No.: 17/879,916

(22) Filed: Aug. 3, 2022

Related U.S. Application Data
(60) Provisional application No. 63/235,689, filed on Aug. 21, 2021.

(51) Int. Cl. C23F 17/00; C23F 1/00; C25D 5/40; B33Y 40/20

(52) U.S. Cl. CPC C23F 17/00; C23F 1/00; C25D 5/40; B33Y 40/20

(57) ABSTRACT

The present invention is a system and method for electroplating and etching, which provides a solution to the problem of smoothing rough exterior features of a 3D printed or otherwise roughly manufactured object with rough exterior features. The core components of the invention are an acid bath with a first electrode and a target object as a second electrode which are in the acid bath. The first electrode and the target object are connected to a power source that causes a current to run in a first direction to etch the target object and in a second direction to plate on the target object. The amount of different metals dissolved in the acid solution will affect the composition of plated material on the target object.

### CROSS REFERENCE TO RELATED APPLICATIONS

This application claims priority to U.S. Provisional Patent No. 63/235,689 filed on Aug. 21, 2021 which is incorporated in its entirety.

### BACKGROUND

Electroplating and electro etching are processes which are already known and used. In either case, a metal object is submerged in an acid bath and used as an electrode as current is run through the acid. If the metal object is the cathode of the electric current, then metal dissolved in the acid will plate onto the metal object. Conversely, if the metal object is the anode, then metal will be etched from the metal object.

These two processes have been used separately for their particular purposes but very little has been done to make these processes work together to affect the shape and consistency of metal objects.

### SUMMARY

The disclosed process is unique when compared with other known devices and solutions because it provides a method for using electroplating and etching to affect the shape and consistency of a target object. The target object may be etched and plated onto repeatedly in an acid solution with a selected metallic composition which will cause the metal plated onto the target object to have a particular composition. Accordingly, by selecting the amount of metal dissolved in the acid and the amount of time that metal is etched and plated on to the target object, the consistency of the metal plated on the target object as well as how much of the original material of the target object is dissolved and how much metal is plated onto the target object can be controlled.

This process can be applied to any metal object being used as the target object but may have particular advantages for 3D printed metal objects. The current 3D printing process involves many thin layers of metal being laid down sequentially to build the 3D printed object. Each layer of metal is laid down as a fairly flat slab. The flat layers cause sloped areas to appear as tiny stair structures. Because etching occurs based on surface area, and plating occurs based on surface area as well, the process of etching and plating sequentially causes these tiny stair structures to be flattened out. The etching process removes more from the forward corners of the stairs and the plating process fills in more of the inner corners of the stairs. This cycle of etching and plating may be called an electro-smoothing process and, if repeated several times, can cause the stairs to appear more as a wave, and then after more cycles, may appear smooth.

3D printing can be used to make parts that would be very difficult or expensive to forge, machine, or cast. However, some components need smooth surfaces to function properly. Often, significant amounts of machining is used to smooth out areas. This process can be laborious and expensive, and cannot be used on all geometries. The process discussed herein may be used to great effect on 3D printed objects that would otherwise need significant grinding to flatten and smooth out the stair-like structures of sloped sides or cannot be processed using conventional machining.

3D printing processes that use powder to create each layer also create surfaces which are much rougher than other manufacturing processes (such as rolled steel or casting). The electro-smoothing process may also greatly improve the smoothness of the surfaces of 3D printed objects.

### BRIEF DESCRIPTION OF DRAWINGS

FIG. 1 shows an example schematic view of an electroplating/etching bath.

FIG. 2 shows an example flow diagram of operations performed in an electro- smoothing process.

### DETAILED DESCRIPTION

In the Summary above, in this Detailed Description, the claims below, and in the accompanying drawings, reference is made to particular features of the invention. It is to be understood that the disclosure of the invention in this specification includes all possible combinations of such particular features. For example, where a particular feature is disclosed in the context of a particular aspect or embodiment of the invention, or a particular claim, that feature can also be used—to the extent possible—in combination with and/or in the context of other particular aspects and embodiments of the invention, and in the invention generally.

The term “comprises” and grammatical equivalents thereof are used herein to mean that other components, ingredients, steps, etc. are optionally present. For example, an article “comprising” (or “which comprises”) components A, B, and C can consist of (i.e., contain only) components A, B, and C, or can contain not only components A, B, and C but also contain one or more other components.

Where reference is made herein to a method comprising two or more defined steps, the defined steps can be carried out in any order or simultaneously (except where the context excludes that possibility), and the method can include one or more other steps which are carried out before any of the defined steps, between two of the defined steps, or after all the defined steps (except where the context excludes that possibility).

The term “at least” followed by a number is used herein to denote the start of a range including that number (which may be a range having an upper limit or no upper limit, depending on the variable being defined). For example, “at least 1” means 1 or more than 1. The term “at most” followed by a number is used herein to denote the end of a range, including that number (which may be a range having 1 or 0 as its lower limit, or a range having no lower limit, depending upon the variable being defined). For example, “at most 4” means 4 or less than 4, and “at most 40%” means 40% or less than 40%. When, in this specification, a range is given as “(a first number) to (a second number)” or “(a first number)−(a second number),” this means a range whose limits include both numbers. For example, “25 to 100” means a range whose lower limit is 25 and upper limit is 100 and includes both 25 and 100.

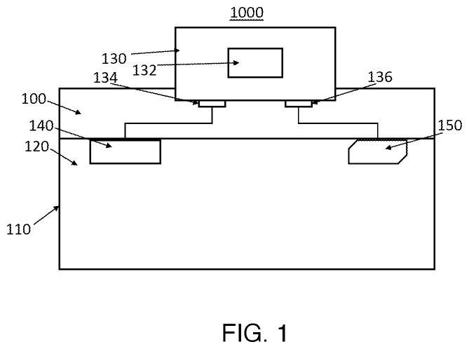

FIG. 1 shows an example schematic view of an electroplating/etching bath (or bath) 1000. The bath 1000 may include a tub 110, an acid 120, a power source 130, a first electrode 140, and a target object 150 acting as a second electrode. The tub 110 may be a basin, beaker, or other similar structure configured to secure an acid solution. The tub 110 may include or be made entirely of a material that does not react to acids, such as glass or certain plastics. As will be discussed in greater detail below, the acid solution 120 may include an acid (such as sulfuric acid, phosphoric acid, and/or hydrochloric acid) and metals dissolved in the acid. The concentration of the different acids and metals in the acid solution cause the acid solution to etch and plate on the target object 150 at different rates and consistencies.

The power source 130 may include a controller 132, a first output 134, and a second output 136. The power source 130 may generate a current and/or a voltage that causes a current that flows from the first output 134 to the second output 136 or from the second output 136 to the first output 134. The controller 132 may include a processor and memory, or other control hardware capable of controlling the current and/or voltage generated by the power source 130.

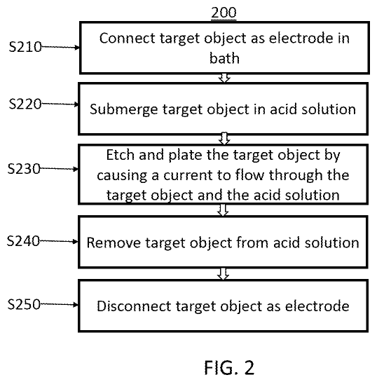

FIG. 2 shows an example flow diagram 200 of operations performed in the electro-smoothing process. At S210, the first electrode 140 may be connected to the first output 134 of the power source 130 and the target object 150 may be connected to the second output 136 as a second electrode. At S220, the first electrode 140 and the target object 150 may be submerged in the acid solution 120 in the tub 110. The acid solution may be selected or mixed to modify the surface of the target object. For example, strength of the acid in the acid solution 120 may determine the rate at which the target object 150 is etched for a given current in a first direction being passed through the target object 150. As another example, the metals and other elements dissolved in the acid in the acid solution 120 may be plated onto the target object 150 when a current in the second direction opposite the first direction is passed through the target object 150. When a current is passed in the first direction, the target object 150 may act as an anode, and when a current is passed in the second direction, the target object 150 may act as a cathode.

The material of the first electrode 140 may be selected for the plating process as well. During the electroplating process of the electro-smoothing process, some of the first electrode may be dissolved into the acid solution 120 and portions of the metal dissolved from the first electrode 140 may be plated onto the target object 150. Accordingly, the first electrode 140 may be made of a material that may be desired to be plated onto the target object 150. In one or more non-limiting embodiments the plating process uses metals already in acid solution 120 and metal etched from target object 150. The metal is etched from target object 150 and mixed with the metal already in acid solution 120, then the mixture is plated back on the surface. This allows for plating a compatible surface material that is modified for a specific purpose (corrosion resistance, wear resistance, etc.). It should be noted that it is acceptable if the counter electrode is inert (e.g., platinum) or is the same composition as the target metal because it will not really contaminate the solution.

At S230, the electro-smoothing may take place by etching and plating the target object 150 by the controller 132 causing the power source 130 to induce a current to flow through the target object 150 and the acid solution 120. One example of the electro-smoothing process is a target object 150 of 3D printed austenitic stainless steel (e.g., SS316) with an acid solution 120 of sulfuric acid and phosphoric acid at a 1:1 ratio and 50 g/l of chromium sulfate. The process may be performed at a temperature of 70 degrees Celsius. The power source 130 may act as a voltage source with a voltage difference between the first output 134 and the second output 136 of 10 volts during etching and plating. The electro-smoothing process may include 5 cycles of etching and plating wherein each etching is for 1 minute and each plating is for 10 minutes. The electro-smoothing process may result in a smoothed exterior of the target object 150 with a layer of stainless steel (with about 20-30% chromium) on the exterior of the target object 150 for improved corrosion resistance of the target object 150.

Another example of the electro-smoothing process is a target object 150 of 3D printed tool steel (e.g., ANSI4340) with an acid solution 120 of sulfuric acid and phosphoric acid at a 1:1 ratio and 25 g/l of chromium sulfate and 100 g/l of manganese sulphate. The process may be performed at a temperature of 25 degrees Celsius. The power source 130 may act as a voltage source with a voltage difference between the first output 134 and the second output 136 of 7 volts during etching and plating. The electro-smoothing process may include 5 cycles of etching and plating wherein each etching is for 0.5 minute and each plating is for 5 minutes. The electro-smoothing process may result in a smoothed exterior of the target object 150 with a layer of case-hardened stainless steel (with about 5-10% chromium and 15-25% manganese) on the exterior of the target object 150 for improved wear resistance of the target object 150. In this case, at least one of the metals dissolved in the acid of the acid solution 120 is not included in the target object before the target object is submerged in the acid solution and the plating introduces a new metal to the target object 150.

Yet another example of the electro-smoothing process is a target object 150 of 3D printed nickel super alloy (e.g., IN718) with an acid solution 120 of 85% hydrochloric acid (aqueous) and acetic acid at a 1:1 ratio and 40 m1/l of nitric acid and 100 g/l of molybdic acid. The process may be performed at a temperature of 50 degrees Celsius. The power source 130 may act as a current source with a current density of 1/0.5 Amps/cm2 during etching and plating. The electro-smoothing process may include 5 cycles of etching and plating wherein each etching is for 0.5 minute and each plating is for 2 minutes. The electro-smoothing process may result in a smoothed exterior of the target object 150 with a layer of molybdenum nickel alloy (with about 5-15% molybdenum) on the exterior of the target object 150 for improved acid resistance of the target object 150.

At S240, the target object 150 and the first electrode 140 may be removed from the acid solution. At S240, the target object 150 may be disconnected from the power source 130 so that the target object 150 may be used for its intended purpose of manufacture.

The electro-smoothing process may be used on target objects 150 including any sort of metal including iron, steel, nickel, titanium, chromium, gold, platinum, palladium, etc. Some metals such as titanium may be etched most efficiently with powerful acids (such as hydrochloric acid), while other metals such as nickel may have better results in some circumstances with less potent acids such as phosphoric acid.

In the etching and plating cycle, much of the metal that is etched away from the target object 150 may be plated back on to the target object 150. In addition, metal additives may be added to the surface to make the surface better for carburization and other similar processes. For instance, carburization process may be performed on the steel to reintroduce or increase carbon in the surface of the target object 150 to increase hardness, strength, and consistency of the material. Similar processes using heating and introduction of gasses to the target object 150 may be used for adding materials such as carbon, nitrogen, boron, and other materials to a metal and to adjust the content of these materials at the surface of the target object 150.

Each metal may be etched and plated at a different rate. For example, in tool steel that includes iron and nickel, the nickel may be more easily etched and plated. In a well-mixed alloy, the amount of nickel that can be dissolved (etched) is limited by the iron it is mixed with but during plating the nickel may plate back on the target object 150 at a higher rate than the iron (if no other metal other than the metal dissolved from the target object 150 is included in the acid solution 120). Accordingly, if it is desired to have the same alloy of nickel and iron at the surface of the target object 150 as in an interior of the target object 150, iron may be added to the acid solution 120 so that the iron and nickel will plate on at the correct rate for the alloy mixture of iron and nickel to be consistent throughout the target object 150. Accordingly, the acid solution may include a mixture of materials such that the plating plates on a substantially similar mixture (each material being within about 10% of the original mixture) of materials was etched during the etching by the first current.

The timing (length of time) of etching and plating may change for different cycles. For example, it may be beneficial to have a first etch cycle be longer than subsequent cycles so that small surface anomalies (such as partially connected metal swarf) can be removed before the plating process adds material to the anomalies, making them harder to remove and taking away from the smoothness of the target object. Furthermore, etch and plating cycles may increase in length as the number of cycles increases. The smoothing effect of the etching and plating reduces the surface area of the target object, accordingly, the amount etched and plated reduces as well for each minute of the etching and plating during later cycles of the electro-smoothing process.

In some cases, for example when a weak acid is being used, it may be advantageous to use a first electrode 140 made of a metal that will not be significantly etched by the acid solution such as platinum or tungsten (the etching is not significant if it results in less than about 1 g/l of the metal in the acid solution 120 during the entire electro-smoothing process). In other situations, the first electrode may be made of a metal or material with one or more of the same component materials as the target object 150 or the desired inclusion or plating. For example, if target object 150 is primarily tool steel with nickel and iron and chromium is the desired inclusion for plating, the first electrode may be made of one or more of iron, nickel, and chromium.

Various catalysts exist for plating and etching, which may also be used in the electro-smoothing process. The timing and voltages of the etching and plating cycles may be adjusted when these catalysts are introduced.

The electro-smoothing process described above may be used for any sort of smoothing of metals but may be particularly useful for 3D printed objects which have rough surfaces and form stair-like structures during manufacture. The electro-smoothing process may be used for smaller structures so it does not round corners too much where they are desired. The amount of time spent etching (and also plating) the target material 150 may be adjusted based on the size of features that are desired to be smoothed in the electro-smoothing process. The electro-smoothing process may have an amount of dissolved material including metals in the acid solution 120 that cause the surface of the target object 150 to maintain an alloy/mixture of materials or to plate on a new alloy/mixture on the surface of the target object 150.

Accordingly, the present description provides for various embodiments for an electro-smoothing process. Many uses and advantages are offered by the electro-smoothing process as described above in one or more non-limiting embodiments in the present description.

The corresponding structures, materials, acts, and equivalents of any means or step plus function elements in the claims below are intended to include any structure, material, or act for performing the function in combination with other claimed elements as specifically claimed. The description of the present invention has been presented for purposes of illustration and description but is not intended to be exhaustive or limited to the invention in the form disclosed. Many modifications and variations will be apparent to those of ordinary skill in the art without departing from the scope and spirit of the invention.

The embodiments were chosen and described in order to best explain the principles of the invention and the practical application, and to enable others of ordinary skill in the art to understand the invention for various embodiments with various modifications as are suited to the particular use contemplated. The present invention, according to one or more embodiments described in the present description, may be practiced with modification and alteration within the spirit and scope of the appended claims. Thus, the description is to be regarded as illustrative instead of restrictive of the present invention.

What is claimed is:

1. A method for electroplating and etching comprising:
connecting a target object to a power source as an electrode, wherein the power source also includes a first electrode connected to the power source as an additional electrode;
submerging the target object and the first electrode in an acid solution;
causing, via the power source, a first current to pass in a first direction through the target object to etch from the target object into the acid solution; and
causing, via the power source, a second current to pass in a second direction through the target object to plate on to the target object from the acid solution, wherein material is plated onto the target object from the acid solution.

2. The method of claim 1, wherein the target object includes a metal, and the acid solution includes an acid and a metal that has already been in the acid before the first current passes through the target object.

3. The method of claim 2, wherein the metal dissolved in the acid is not included in the target object before the target object is submerged in the acid solution.

4. The method of claim 2, wherein the acid solution includes a mixture of materials such that the plating by the second current plates on a substantially similar mixture of materials as was etched during the etching by the first current.

5. The method of claim 2, wherein the acid solution includes a mixture of materials such that the plating by the second current plates on a modified mixture of materials, the modified mixture of materials being different in composition from material etched from the target object during the etching by the first current.

6. A system for electroplating and etching comprising:
a power source including a controller, a first output, and a second output, wherein the power source generates a current or a voltage that causes a current that flows from the first output to the second output and from the second output to the first output, wherein the controller includes a processor and memory for controlling the current or the voltage generated by the power source.

7. The system of claim 6, further comprising: a tub for containing an acid solution.

8. The system of claim 7, further comprising: a target object, wherein the target object includes a metal, and the acid solution includes an acid and a material including a metal dissolved in the acid before a first current passes through the target object.

9. The system of claim 8, wherein the metal dissolved in the acid solution is not included in the target object before the target object is submerged in the acid solution.

10. The system of claim 7, wherein the acid solution includes a mixture of materials such that plating by a second current plates on a substantially similar mixture of materials as was etched during the etching by a first current.

11. The system of claim 8, wherein the acid solution includes a mixture of materials such that plating by a second current plates on a modified mixture of materials, the modified mixture of materials being different in composition from material etched from the target object during the etching by a first current.

12. A method for electroplating and etching comprising:
connecting a target object to a power source as an electrode, wherein the power source includes a controller, a first output, and a second output wherein the second output includes a first electrode connected to the power source as an additional electrode; and
submerging the target object and the first electrode in an acid solution in a container, wherein the power source permits a first current to pass in a first direction through the target object to etch from the target object into the acid solution and permits a second current to pass in a second direction through the target object to plate on to the target object from the acid solution, wherein material is plated onto the target object from the acid solution which was not etched from the target object.

13. The method of claim 12, wherein the target object includes a metal, and the acid solution includes an acid and a material including a metal already in the acid before the first current passes through the target object.

14. The method of claim 13, wherein the metal already in the acid is mixed with the metal etched from the target object and then plated back onto the target object.

15. The method of claim 12, wherein the acid solution includes a mixture of materials such that the plating by the second current plates on a substantially similar mixture of materials as was etched during the etching by the first current.

16. The method of claim 12, wherein the acid solution includes a mixture of materials such that the plating by the second current plates on a modified mixture of materials, the modified mixture of materials being different in composition from material etched from the target object during the etching by the first current.

17. The method of claim 12, further comprising: performing a carbonization process to reintroduce or increase carbon on a surface of the target object to increase hardness, strength, and consistency.

18. The method of claim 13, further comprising: submerging a 3D printed tool steel with the acid solution of sulfuric acid and phosphoric acid and 25 g/l of chromium sulfate and 100 g/l of manganese sulphate at a temperature of 25 degrees Celsius, wherein the power source acts as a voltage source with a voltage difference between the first output and the second output of 7 volts during etching and plating.

19. The method of claim 13, further comprising: submerging a 3D printed austenitic stainless steel with the acid solution of sulfuric acid and phosphoric acid and 50 g/l of chromium sulfate performed at a temperature of 70 degrees Celsius wherein the power source acts as a voltage source with a voltage difference between the first output and the second output of 10 volts during etching and plating.

20. The method of claim 13, further comprising: submerging a 3D printed nickel super alloy as the target solution with the acid solution of 85% hydrochloric acid and acetic acid and 40 ml/l of nitric acid and 100 g/l of molybdic acid performed at a temperature of 50 degrees Celsius wherein the power source acts as a current source with a current density of 1/0.5 Amps/cm2 during etching and plating, wherein the method includes 5 cycles of etching and plating wherein each etching is for 0.5 minute and each plating is for 2 minutes.
